(19) United States
(12) Patent Application Publication
(10) Pub. No.: US 2003/0096607 A1
(43) Pub. Date: May 22, 2003

(54) Maintenance/trouble signals for a RF wireless locking system

(76) Inventor: Ronald Taylor, Wheaton, IL (US)

Correspondence Address: McAndrews, Held & Malloy, Ltd., 34th Floor, 500 W. Madison Street, Chicago, IL, 60661, US

(21) Appl. No.: 10/262,508

(22) Filed: Sep. 30, 2002

Related U.S. Application Data
(60) Provisional application No. 60/326,338, filed on Sep. 30, 2001.
(60) Provisional application No. 60/326,299, filed on Sep. 30, 2001.
(60) Provisional application No. 60/326,201, filed on Sep. 30, 2001.
(60) Provisional application No. 60/326,316, filed on Sep. 30, 2001.
(60) Provisional application No. 60/326,298, filed on Sep. 30, 2001.
(60) Provisional application No. 60/326,179, filed on Sep. 30, 2001.
(60) Provisional application No. 60/326,296, filed on Sep. 30, 2001.
(60) Provisional application No. 60/326,294, filed on Sep. 30, 2001.
(60) Provisional application No. 60/326,295, filed on Sep. 30, 2001.

(51) Int. Cl. H04Q 7/20

(52) U.S. Cl. 455/425; 455/423

(57) ABSTRACT

A system for error notification in a wireless remote access system includes a remote access unit generating a trouble signal in response to a trouble condition at the remote access unit and a wireless panel interface receiving the trouble signal from the remote access unit and transmitting the trouble signal to report the trouble condition. The trouble signal may be a low battery signal, a no communications signal, a remote access unit tamper signal, a lock motor stall signal, and/or a wireless panel interface tamper signal. The wireless panel interface may transmit the trouble signal to a remote access control panel and/or an operator. Trouble conditions may be indicated at the remote access unit, wireless panel interface, and/or remote access control panel using an indicator, such as an audio indicator and/or a visual indicator.

### RELATED APPLICATIONS

The present application claims priority to the following provisional applications all filed Sep. 30, 2001: Application No. 60/326,338, entitled “RF Channel Linking Method and System”; Application No. 60/326,299, entitled “Energy Saving Motor-Driven Locking Subsystem”; Application No. 60/326,201 entitled “Cardholder Interface for an Access Control System”; Application No. 60/326,316, entitled “System Management Interface for Radio Frequency Access Control”; Application No. 60/326,298 entitled “Power Management for Locking System”; Application No. 60/326,179, entitled “General Access Control Features for a RF Access Control System”; Application No. 60/326,296, entitled “RF Wireless Access Control for Locking System”; Application No. 60/326,294, entitled “Maintenance/Trouble Signals for a RF Wireless Locking System”; and Application No. 60/326,295, entitled “RF Dynamic Channel Switching Method.”

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The preferred embodiments of the present invention relate to an RF access control system for controlling access to an access point. More specifically, the preferred embodiments of the present invention relate to a system and method for signaling between elements of an RF access control system to indicate failures or other problems occurring in the elements.

A wireless access control system may provide several advantages over a traditional, wire-based access control system. In a traditional, wired access control system, each access point, such as a door, for example, is equipped with a locking module to secure the access point. Each locking module is in turn directly wired to a remote access control module. The access control module is typically a database that compares a signal received from the locking module to a stored signal in the database in order to determine an access decision for that locking module. Once the access decision has been determined by the access control module, the decision is relayed to the locking module through the wired connection.

The use of wired connections between the access control module and the locking module necessitates a large investment of time and expense in purchasing and installing the wires. For example, for larger installations, literally miles of wires must be purchased and installed. An access control system that minimizes the time and expense of the installation would be highly desirable.

Additionally, wire-based systems are prone to reliability and security failures. For example, a wire may short out or be cut and the locking module connected to the access control module by the wire may no longer be under the control of the access control module. If a wire connection is cut or goes, the only alternative is to repair the faulty location (which may not be feasible) or run new wire all the way from the access control module to the locking module, thus incurring additional time and expense. Conversely, an access control system that provides several available communication channels between the locking module and the access control module so that if one communication channel is not usable, communication may proceed on one of the other communication channels, would also be highly desirable, especially if such an access control system did not add additional costs to install the additional communication channels.

A wireless access system providing a wireless communication channel between the locking module and the access control module may provide many benefits over the standard, wire-based access control system. Such a wireless access system is typically less expensive to install and maintain due to the minimization of wire and the necessary installation time. Additionally, such a system is typically more secure because communication between the locking module and the access control module is more robust that a single wire.

However, one difficulty often encountered in installing and maintaining such a wireless access system is detecting and flagging errors and faults in the system. For example, a wireless system component may break or go offline unknown to the rest of the system.

Consequently, the system may continue to attempt to communicate with faulted components with negative results for system functionality and stability. Access requests may be lost and doors may be unintentionally locked or unlocked. A system that transmits a warning signal to indicate an error or trouble in the system would be highly desirable. Additionally, a system that identifies the system fault or maintenance request would be highly desirable.

### BRIEF SUMMARY OF THE INVENTION

Preferred embodiments of the present invention provide a method and system for power management in an access control system. A method for signaling a trouble condition in a remote access unit of a wireless remote access system includes monitoring a remote access unit to receive a trouble signal from the remote access unit, generating a trouble signal based on a trouble condition at the remote access unit, and transmitting the trouble signal to report the trouble condition. The trouble signal may be a low battery signal indicating that a power supply in the remote access unit is low. The trouble signal may also be a no communications signal indicating that no transmissions have been received from the remote access unit for at least two predetermined intervals. The trouble signal may also be a remote access unit tamper signal indicating that the remote access unit has been tampered with. Additionally, the trouble signal may be a lock motor stall signal indicating that a motor driving a lock on a door controlled by the remote access unit is stalled. Furthermore, the trouble signal may be a WPIM tamper signal indicating that an access panel for a wireless panel interface has been opened.

Transmission of the trouble signal may include transmitting the trouble signal to a wireless panel interface. The trouble signal may also include transmitting the trouble signal to a remote access control panel. An operator may also be notified of the trouble condition. The trouble condition may also be indicated at the remote access unit, wireless panel interface, and/or remote access control panel.

A system for error notification in a wireless remote access system includes a remote access unit generating a trouble signal in response to a trouble condition at the remote access unit and a wireless panel interface receiving the trouble signal from the remote access unit and transmitting the trouble signal to report the trouble condition. The trouble signal may be a low battery signal, a no communications signal, a remote access unit tamper signal, a lock motor stall signal, and/or a wireless panel interface tamper signal. The wireless panel interface may transmit the trouble signal to a remote access control panel and/or an operator. Trouble conditions may be indicated at the remote access unit, wireless panel interface, and/or remote access control panel using an indicator, such as an audio indicator and/or a visual indicator.

### BRIEF DESCRIPTION OF SEVERAL VIEWS OF THE DRAWINGS

FIG. 1 illustrates a block diagram of the components of a wireless access system according to a preferred embodiment of the present invention.

FIG. 2 illustrates a block diagram of the components of an expanded wireless access system according to a preferred embodiment of the present invention.

FIG. 3 illustrates a Wireless Access Point Module (WAPM) for the wireless access system of FIG. 1 according to a preferred embodiment of the present invention.

FIG. 4 illustrates a WPIM for the wireless access system of FIG. 1 according to a preferred embodiment of the present invention.

### DETAILED DESCRIPTION OF THE INVENTION

The present application is directed toward a portion of a wireless access system. Additional disclosure of the wireless access system may be found in the following co-filed applications which are hereby incorporated by reference in their entirety: Application No. xx/xxx,xxx, entitled “RF Channel Linking Method and System” filed Sep. 30, 2002; Application No. xx/xxx,xxx, entitled “Energy Saving Motor-Driven Locking Subsystem” filed Sep. 30, 2002; Application No. xx/xxx,xxx entitled “Cardholder Interface for an Access Control System” filed Sep. 30, 2002; Application No. xx/xxx,xxx, entitled “System Management Interface for Radio Frequency Access Control” filed Sep. 30, 2002; Application No. xx/xxx,xxx entitled “Power Management for Locking System” filed Sep. 30, 2002; Application No. xx/xxx,xxx, entitled “General Access Control Features for a RF Access Control System” filed Sep. 30, 2002; Application No. xx/xxx,xxx, entitled “RF Wireless Access Control for Locking System” filed Sep. 30, 2002; Application No. xx/xxx,xxx, entitled “Maintenance/Trouble Signals for a RF Wireless Locking System” filed Sep. 30, 2002; and Application No. xx/xxx,xxx, entitled “RF Dynamic Channel Switching Method” filed Sep. 30, 2002.

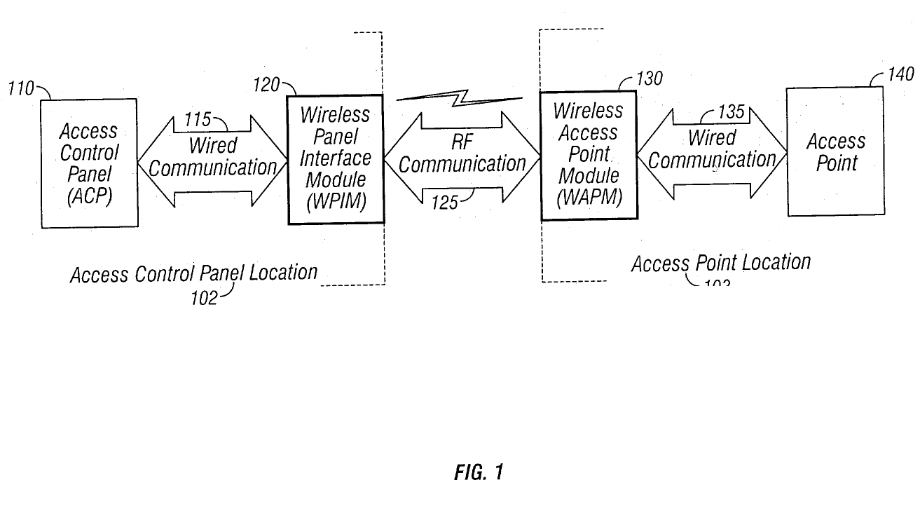

FIG. 1 illustrates a block diagram of the components of a wireless access system 100 according to a preferred embodiment of the present invention. The wireless access system 100 includes several components installed at one of two generalized locations, an access control panel location 102 and an access point location 103. The access control panel location 102 includes an access control panel (ACP) 110 and a Wireless Panel Interface Module (WPIM) 120. The access point location 103 includes a Wireless Access Point Module (WAPM) 130 and an access point 140. The access control panel 110 communicates with the WPIM 120 through a bi-directional wired communication link 115. The WPIM 120 communicates with the WAPM 130 through a bi-directional RF communication link 125. The WAPM 130 communicates with the access point 140 through a bi-directional wired communication link 135. The access point 140 is preferably a door or portal, but may be a container, secure location, or a device of some kind, for example.

In operation, an access signal is read at the access point 140. The access signal may be a signal from an access card, for example, a magnetic stripe or Wiegand access card. Alternatively, the access signal may be a biometric or a numeric sequence or some other access signal. The access signal is relayed from the access point 140 to the WAPM 130 through the wired communication link 135. As further described below, the access point 140 may be integrated into the WAPM 130 to form a single component or may be a separate component wired to the WAPM 130.

Once the WAPM 130 receives the access signal from the access point 140, the WAPM 130 transmits the access signal to the WPIM 120 over the RF communication link 125. The WPIM 120 receives the access signal and relays the access signal to the ACP 110 over the wired communication link 115.

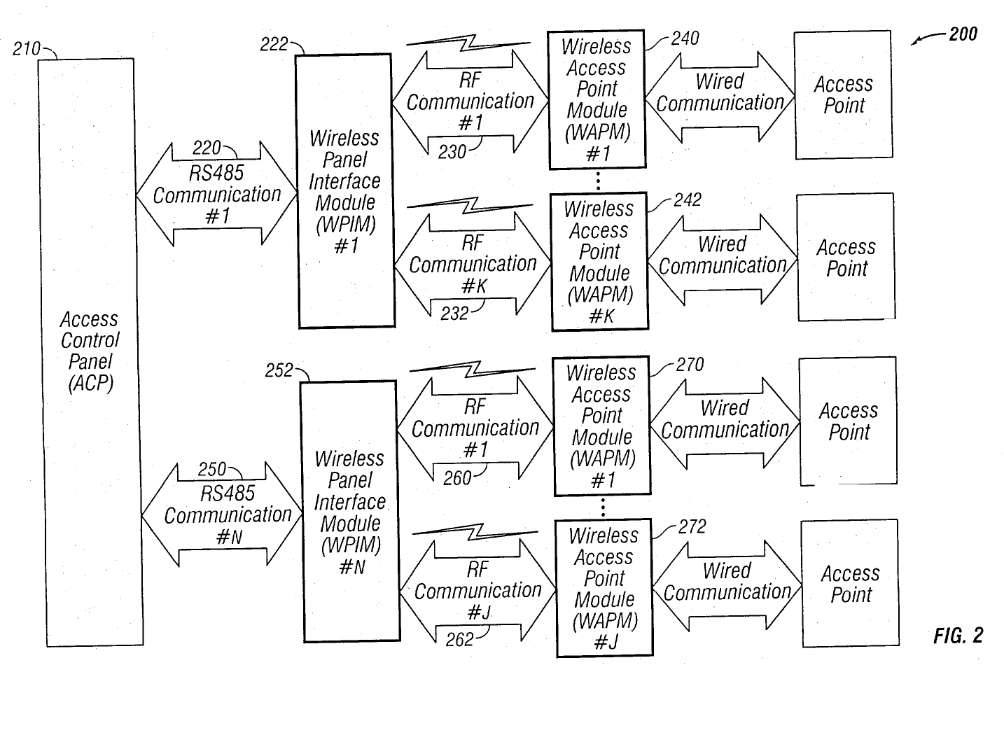

FIG. 2 illustrates a block diagram of the components of an expanded wireless access system 200 according to a preferred embodiment of the present invention. The expanded wireless access system 200 includes an ACP 210, multiple wired communication links 220, 222 numbered 1 to N, multiple WPIMs 222, 252 numbered 1 to N, multiple RF communication links 230, 2323, 260, 262 numbered 1 to K and 1 to J, and multiple WAPMs 240, 242, 270, 272 numbered 1 to K and 1 to J. The expanded wireless access system 200 is similar to the access system 100 of FIG. 1, and includes the same components, but has been expanded to include multiple access points, WAPMs, and WPIMs.

In the expanded wireless access system 200, a single ACP 210 communicates with a number N of WPIMs 222, 252 over a number N of wired communication links 220, 250. That is, the ACP supports communication with and provides access decisions for plurality of WPIMs 222, 252. Each WPIM 222, 252 may in turn support a plurality of WAPMs 240, 242, 270, 272 each WAPM positioned at a single access point. For example, WPIM #1 communicates with a number K of WAPMs 240, 242 over a number K of RF communication links 230, 232. Additionally, WPIM #N communicates with a number J of WAPMs 270, 272 over a number J of RF communication links 260, 262.

In a preferred embodiment, the ACP 210 supports three WPIMs and each PIM can support up to six WAPMs. However, as more advanced and configurable systems are developed, the total numbers of WPIMs and WAPMs supported is expected to rise. Additionally, the N wired communication links 220, 250 are illustrated as the preferred embodiment of RS486 communication links. Alternatively, other well-known communication protocols may be employed.

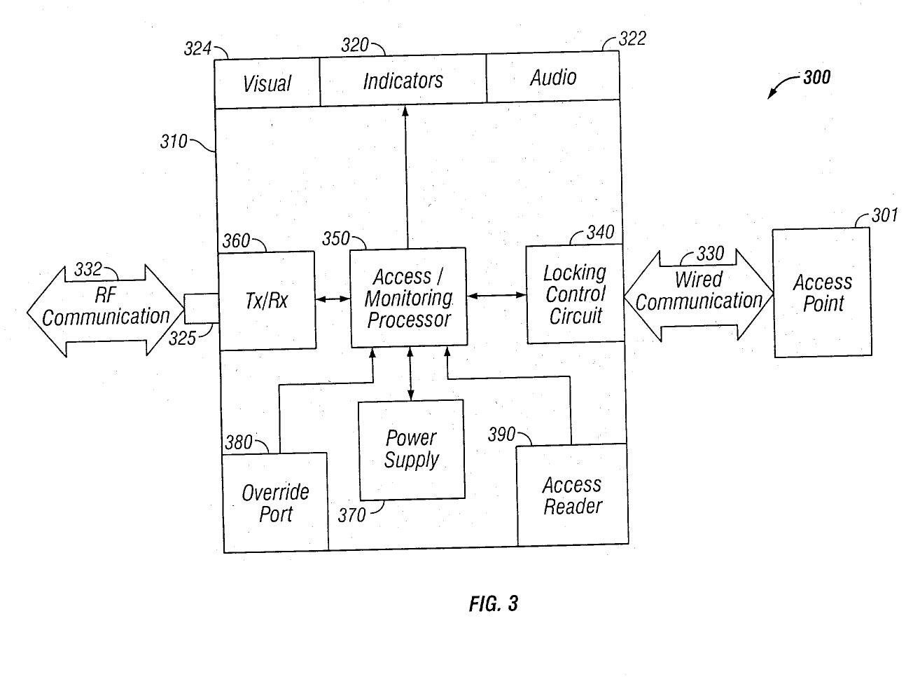

FIG. 3 illustrates a Wireless Access Point Module (WAPM) 300 for the wireless access system 100 of FIG. 1 according to a preferred embodiment of the present invention. The WAPM 300 includes a housing 310, indicators 320, a wired communication link 330, a RF communication link 332, and an antenna 325. The housing 310 includes a locking control circuit 340, an access/monitoring processor 350, a transceiver 360, a power supply 370, an override port 380, and an access reader 390. The indicators 320 may include one or both of an audio indicator 322 and a visual indicator 324. An access point 301 is also shown in FIG. 3.

The power supply 370 provides power to all of the other systems of the housing 310, including the transceiver 360, the locking control circuit 340, and the access/monitoring processor 350. The power supply 370 may be an internal battery or other internal type of power supply. Alternatively, an AC power supply may be employed. The transceiver 360 is coupled to the antenna 325 to allow signals to be sent and received from the housing 310 to an external point such as a WPIM through the RF communication link 332. The locking control circuit 340 is coupled to the access point 301 and provides locking control signals to the access point 301 through the wired communication link 330. Additionally, the locking control circuit 340 may receive feedback from the access point 301 through the wired communication link 330, for example to verify that the access point is secured. The access reader 390 receives access signals such as from an integrated card reader or other access device, for example. The indicators 320 may provide a visual or audio indication, for example of the state of the WAPM 300 or that an access signal has been read by the access reader 390.

In operation, an access signal may be received from the access reader 390. The access signal is then relayed to the access/monitoring processor 350. The access/monitoring processor 350 then sends the access signal to the transceiver 360. The transceiver 360 transmits the access signal to WPIM 120 of FIG. 1 that is interfaced to the ACP 110. As further explained below, the ACP 110 includes a database of authorized access signals. If the access signal received from the WAPM 300 is determined by the ACP 110 to be a signal corresponding to an authorized user, a confirmation is transmitted from the ACP 110 to the WPIM 120 and then to the transceiver 360 of the WAPM 300. The confirmation is relayed from the transceiver 360 to the access/monitoring processor 350. The access/monitoring processor 350 then sends a locking control signal to the locking control unit 340. When the locking control unit 340 receives the locking control signal, the locking control unit 340 activates the access point 301 through the wired communication link 330 to allow access. The indicators 320 may be a visual or audible signal that the housing 310 has read an access signal, transmitted the access signal to the remote access control panel, received a confirmation, or activated the locking member, for example.

The WAPM 300 may include several variations. For example, the WAPM may be an Integrated Reader Lock (IRL), a Wireless Reader Interface (WRI), a Wireless Integrated Strike Interface (WISI), a Wireless Universal Strike Interface (WUSI), or a Wireless Portable Reader (WPR). The IRL includes an integrated access reader and lock. That is, the IRL is similar to FIG. 3, but includes the access point as part of the housing. The WRI is similar to the IRL, but does not include an integrated access reader and instead receives signals from a third party access reader. The WISI includes an integrated reader and lock and is mounted directly into the strike of the access point, such as a door, for example. The WUSI is similar to the WISI, but does not include an integrated reader and lock and may instead be connected to a third party reader and/or lock. The WPR is a portable reader that may be taken to a remote location and determine access decisions at the remote location, for example, for security checks or badging checks.

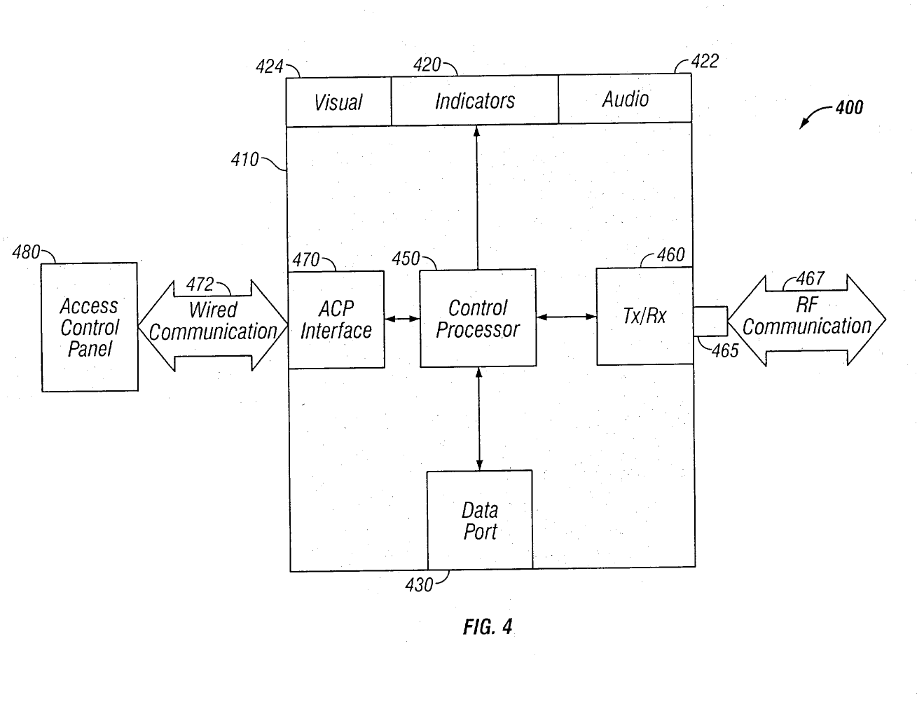

FIG. 4 illustrates a WPIM 400 for the wireless access system 100 of FIG. 1 according to a preferred embodiment of the present invention. The WPIM 400 includes a housing 410, an antenna 465, and indicators 420. The housing 410 includes a data port 430, a control processor 450, a transceiver 460 and an ACP interface 470. FIG. 4 also shows an RF communication link 467, a wired communication link 472, and an ACP 480.

Power is typically supplied to the WPIM via an AC power supply or through the wired communication 472. The transceiver 460 is coupled to the antenna 465 to allow signals to be sent and received from the housing 410 to an external point such as a WAPM through the RF communication link 467. The ACP 480 is coupled to the WPIM 400 through the wired communication link 472. The data port 430 is coupled to the control processor 450 to allow an external user such as a technician, for example, to interface with the control processor. The indicators 420 may provide a visual or audio indication, for example of the state of the WPIM 400 or that an access signal has been passed to the ACP 480 or an authorization passed to a WAPM 300.

In operation, the WPIM 400 receives access signals from the WAPM 300 through the antenna 465 and transceiver 460. The WPIM relays the access signals to the ACP 480 for decision making. Once the access decision has been made, the ACP 480 transmits the access decision through the wired communication link 472 to the WPIM 400. The WPIM 400 then transmits the access decision to the WAPM 300.

As mentioned above, the WPIM 400 includes a data port 430. The data port 430 is preferably an RS485 port. The data port 430 may be used, for example, by an operator to connect a computer to the WPIM 400 to perform various tasks, such as configuring the WPIM 400, for example. Some exemplary WPIM items for configuration include the transmission frequency for the communication link with the WAPM 300 and the performance of the indicators 420.

Additionally, configuration information may be received by the data port 430 of the WPIM 400 and relayed to the WAPM 300 via the transceiver 460. The configuration information that is received by the WAPM 300 may then by relayed to the access/monitoring processor 350 of the WAPM 300 for implementation at the WAPM 300.

The WPIM 400 may include several variations including a panel interface module (PIM) and a panel interface module expander (PIME). As mentioned above, a single PIM may communicate with multiple WAPMs. Additionally, the housing for the PIM is preferably constructed to allow additional PIM modules to be installed in the PIM housing to form the PIME. Because the PIME includes multiple PIM modules, the PIME may service more access points.

The features of one of the preferred embodiments present a system and method for signaling between elements of the wireless access system 100 to indicate failures or other problems occurring in the elements. In particular, the system 100 provides error detection and notification for system components such as the WAPM 300 and the WPIM 400.

Thus, one aspect of a preferred embodiment of the present invention is a wireless access system 100 that employs maintenance, trouble, and/or warning signals to indicate problems or unusual situations in system components, such as the WAPM 300 and the WPIM 400. As described above, the WPIM 400 receives access signals from the WAPM 300 through the antenna 465 and transceiver 460. In addition to receiving access signals from the WAPM 300, the WPIM 400 preferably also receives maintenance and trouble or warning signals from the WAPM 300. For example, the WPIM 400 preferably receives: a low battery trouble signal, a no communications trouble signal, an access point or reader tamper trouble signal, a lock motor stall trouble signal, and a WPIM tamper trouble signal, for example. The WPIM 400 preferably passes these trouble or maintenance signals on to the access control panel 110 for display to an operator.

With regard to the low battery trouble signal, the WAPM 300 is powered by the power supply 370. During use, the energy held by the power supply 370 is slowly drained. When the energy held by the power supply 370 is exhausted, the WAPM 300 is no longer able to function or communicate with the WPIM 400. Thus, when the WAPM 300 detects that the power supply 370 is only able to provide power for a short additional amount of time (i.e., the power supply is almost exhausted) the WAPM 300 informs the WPIM 400 through the low battery trouble signal. The low battery trouble signal is then relayed from the WPIM 400 to the access control panel 110 for display to an operator so that an operator may replace the power supply 370. Preferably, the low battery trouble signal is sent by the WAPM 300 when approximately one month's worth of power remains in the power supply 370. In certain embodiments, battery status information may be transmitted to the WPIM 400 and access control panel 110.

With regard to the access point or reader tamper trouble signal, the WAPM 300 includes the access reader 390, for example, a card reader. The access reader 390 may be tampered with, for example by someone seeking to gain unauthorized access to through the WAPM 300. When the access reader 390 is tampered with, the WAPM 300 sends the access point tamper trouble signal to the WPIM 400. The WPIM 400 then relays the access point tamper trouble signal to the access control panel 110 for action by an operator. For example, if an unauthorized user breaks the access reader 390 or removes the access reader 390 from the housing 310 of the WAPM 300, possibly in an attempt to gain access through the WAPM 300, an access point tamper switch is activated to initiate the access point tamper signal.

With regard to the lock motor stall trouble signal, the WAPM 300 includes the locking control circuit 340. Preferably, the locking control circuit 340 includes a DC motor and an enabling member, such as a locking shaft driven by a DC motor. If, for any reason the locking shaft has stalled, for example, the DC motor is unable to move the locking shaft, then the lock motor stall trouble signal is sent from the WAPM 300 to the WPIM 400. The WPIM 400 then relays the lock motor stall trouble signal to the access control panel 110 for action by an operator. The lock motor stall trouble signal is one of the most important trouble signals because the WAPM 300 may be stuck in an open or closed position and be unable to move and thereby create a security risk.

With regard to the no communications trouble signal, the WAPM 300 and WPIM 400 are preferably equipped with a heartbeat. That is, the WAPM 300 periodically sends a signal to the WPIM 400 to confirm that the WAPM 300 is still functioning. The heartbeat may be sent in addition to any access signal sent from the WAPM 300 to the WPIM 400. Alternatively, the heartbeat may initiate at a given time after the last access signal transmitted between the WAPM 300 and the WPIM 400. If the WPIM 400 does not receive a heartbeat signal from the WAPM 300 for two consecutive heartbeat intervals, for example, then the WPIM 400 sends the no communications trouble signal to the access control panel 110 to alert an operator. Additionally, the PIM preferably indicates the problem through a link indicator 220, such as an LED, for example. The frequency of the heartbeat signal may set by an operator. In a preferred embodiment of the present invention, the heartbeat is configurable from 0 to 290 hours in 15-second intervals.

With regard to the WPIM tamper trouble signal, the WPIM 400 includes a door or access panel (i.e. a door to the WPIM housing 410), for example providing access to the indicators 420 or other subsystems of the WPIM 400. When the WPIM 400 door is opened, the WPIM tamper trouble signal is sent to the access control panel 110 so that an operator is alerted that the WPIM 400 door has been opened. Opening the WPIM 400 door may indicate trouble with the WPIM 400 or may indicate routine service. For example, the WPIM's 400 cover is opened during installation and configuration of WAPMs 300 and for maintenance. However, an indication that the access door has been opened is sent to the access control panel 110 regardless.

Preferably, in addition to being passed to the access control panel 110, all trouble signals are indicated at the WPIM 400. For example, LEDs or other visual or audible indicators 420, 422, 424 may indicate the presence of a problem or the specific type of problem. Alternatively, instead of relaying each specific trouble signal to the access control panel 110, the WPIM 400 may include a general alarm signal for transmission to the access control panel 110. The presence of any of the trouble signals initiates the general alarm signal. Thus, an operator at the access control panel 110 may receive an indication of a problem at a particular WPIM 400, but must examine the particular WPIM (for example, the WPIM's indicators 420) to determine the nature of the WPIM's 400 problem. The trouble signals may also be indicated at the WAPM 300 using the indicators, 320, 322, 324.

In certain embodiments, the above-described trouble signals may also include a number of heartbeats acknowledged or missed, along with other system status information. Additionally, in certain embodiments, some system components may be idle or de-activated when not in use until a trouble signal is received. When one of the trouble signals is received, the affected component(s) “wake up” to address the problem indicated in the signal or alert the access control panel 110 or an operator of the situation.

While particular elements, embodiments and applications of the present invention have been shown and described, it is understood that the invention is not limited thereto since modifications may be made by those skilled in the art, particularly in light of the foregoing teaching. It is therefore contemplated by the appended claims to cover such modifications and incorporate those features that come within the spirit and scope of the invention.

1. A method for signaling a trouble condition in a remote access unit of a wireless remote access system, said method comprising:
monitoring a remote access unit to receive a trouble signal from said remote access unit;
generating a trouble signal based on a trouble condition at said remote access unit; and
transmitting said trouble signal to report said trouble condition.

2. The method of claim 1, wherein said trouble signal comprises a low battery signal indicating that a power supply in said remote access unit is low.

3. The method of claim 1, wherein said trouble signal comprises a no communications signal indicating that no transmissions have been received from said remote access unit for at least two predetermined intervals.

4. The method of claim 1, wherein said trouble signal comprises a remote access unit tamper signal indicating that said remote access unit has been tampered with.

5. The method of claim 1, wherein said trouble signal comprises a lock motor stall signal indicating that a motor driving a lock on a door controlled by said remote access unit is stalled.

6. The method of claim 1, wherein said trouble signal comprises a WPIM tamper signal indicating that an access panel for a wireless panel interface has been opened.

7. The method of claim 1, wherein said transmitting step further comprises transmitting said trouble signal to a wireless panel interface.

8. The method of claim 1, wherein said transmitting step further comprises transmitting said trouble signal to a remote access control panel.

9. The method of claim 1, wherein said transmitting step further comprises notifying an operator of said trouble condition.

10. The method of claim 1, further comprising indicating said trouble condition at said remote access unit.

11. A system for error notification in a wireless remote access system, said system comprising:
a remote access unit, said remote access unit generating a trouble signal in response to a trouble condition at said remote access unit; and
a wireless panel interface, said wireless panel interface receiving said trouble signal from said remote access unit, said wireless panel interface transmitting said trouble signal to report said trouble condition.

12. The system of claim 11, wherein said trouble signal comprises a low battery signal indicating that a power supply in said remote access unit is low.

13. The system of claim 11, wherein said trouble signal comprises a no communications signal indicating that no transmissions have been received from said remote access unit for at least two predetermined intervals.

14. The system of claim 11, wherein said trouble signal comprises a remote access unit tamper signal indicating that said remote access unit has been tampered with.

15. The system of claim 11, wherein said trouble signal comprises a lock motor stall signal indicating that a motor driving a lock on a door controlled by said remote access unit is stalled.

16. The system of claim 11, wherein said trouble signal comprises a WPIM tamper signal indicating that an access panel for a wireless panel interface has been opened.

17. The system of claim 11, wherein said remote access unit indicates said trouble condition using at least one of an audio indicator and a visual indicator.

18. The system of claim 11, wherein said wireless panel interface indicates said trouble condition using at least one of an audio indicator and a visual indicator.

19. The system of claim 11, wherein said wireless panel interface transmits said trouble signal to a remote access control panel.

20. The system of claim 19, wherein said remote access control panel indicates said trouble condition using at least one of an audio indicator and a visual indicator.
